(19) United States
(12) Patent Application Publication
(10) Pub. No.: US 2025/0225320 A1
(43) Pub. Date: Jul. 10, 2025

(54) METHOD AND SYSTEM FOR GENERATING TEXT SUGGESTS

(71) Applicant: Y.E. Hub Armenia LLC, Yerevan (AM)

(72) Inventors: Vladimir MOROZOV, Druzhinino (RU); Vadim SHCHUKIN, Moscow (RU)

(21) Appl. No.: 19/015,977

(22) Filed: Jan. 10, 2025

(30) Foreign Application Priority Data
Jan. 10, 2024 (RU) 2024100362

(51) Int. Cl. G06F 40/274; G06F 3/04886; G06F 40/40; G06N 3/0464

(52) U.S. Cl. CPC G06F 40/274; G06F 40/40; G06N 3/0464; G06F 3/04886

(57) ABSTRACT

A method and an electronic device for generating text suggests for texts input in applications executed on the electronic device are provided. The method comprises: receiving a textual user input; generating a first vector embedding representative of the textual user input; generating a second vector embedding representative of an application name of a given application of the plurality of applications, to which the textual user input has been made; combining the first and second vector embeddings to generate a combined vector embedding for the textual user input; feeding the combined vector embedding to a natural language processing model (NLPM) to generate a text suggest for the user to select as input, to the given application, following the textual user input; and outputting the text suggest to enable the user of the electronic device to input the text suggest after the textual user input to the given application.

### CROSS-REFERENCE

The present application claims priority to Russian Patent Application No. 2024100362, entitled “Method and System for Generating Text Suggests”, filed Jan. 10, 2024, the entirety of which is incorporated herein by reference.

### FIELD

The present technology relates generally to generating text suggests; and in particular, to a method of and system for generating text suggests for text inputs in applications of an electronic device.

### BACKGROUND

Various applications installable on a personal electronic device (such as a smartphone, a tablet, a laptop, and others) may require a user thereof to input various data. For example, a given messenger application enables the user to input text, images, audio and video files for transmitting as private messages to one of user's contacts. An application of a given social network can allow the user to input text indicative of posts or comments through the user's account on the given social network. In yet another example, a map application typically enables the user to input text including a name or an address of a given geographical location. Typically, the user can make text inputs using either physical or virtual keyboard of the electronic device.

For aiding the user in entering the text data, in response to a given user textual input, such as a word, letter, or a symbol, to the given application, the electronic device can be configured to provide text suggests, which can include at least one of a following word, a full form of the following word, or a correct orthographic form of the following word input by the user.

However, if the electronic device generates the same text suggest in response to the given user textual input in all the applications executed by the electronic device, it may affect user experience of the user from interacting with the electronic device and/or the applications.

More specifically, if in response to the given user textual input including the letter “H”, the electronic device generates the text suggest reading “Hello” in a messaging application, the user may appreciate this suggest. However, if the electronic device outputs this text suggest in response to receiving the letter “H” in an application managing user's contacts or a map application, the user may perceive this suggest as being futile and unhelpful as it does not correspond to a typical lexical context associated with these applications. This may hence lower the user satisfaction from interacting with either one of both the electronic device and the applications executed thereon.

Certain prior art approaches have been proposed to tackle the above-identified technical problem.

U.S. Pat. No. 11,579,730-B2, issued on Feb. 14, 2023, assigned to Capital One Services LLC, and entitled “SYSTEMS FOR REAL-TIME INTELLIGENT HAPTIC CORRECTION TO TYPING ERRORS AND METHODS THEREOF,” discloses systems and methods of that enable context-aware haptic error notifications. The systems and methods include a processor to receive input segments into a software application from a character input component and determine a destination. A context identification model predicts a context classification of the input segments based at least in part on the software application and the destination. Potential errors are determined in the input segments based on the context classification. An error characterization machine learning model determines an error type classification and an error severity score associated with each potential error and a haptic feedback pattern is determined for each potential error based on the error type classification and the error severity score of each potential error of the one or more potential errors. And a haptic event latency is determined based on the error type classification and the error severity score of each potential error.

U.S. Pat. No. 11,573,697-B2, issued on Feb. 7, 2023, assigned to Samsung Electronics Co Ltd, and entitled “METHODS AND SYSTEMS FOR PREDICTING KEYSTROKES USING A UNIFIED NEURAL NETWORK,” discloses methods and systems for predicting keystrokes using a neural network analyzing cumulative effects of a plurality of factors impacting the typing behavior of a user. The factors may include typing pattern, previous keystrokes, specifics of keyboard used for typing, and contextual parameters pertaining to a device displaying the keyboard and the user. A plurality of features may be extracted and fused to obtain a plurality of feature vectors. The plurality of feature vectors can be optimized and processed by the neural network to identify known features and learn unknown features that are impacting the typing behavior. Thereby, the neural network predicts keystrokes using the known and unknown features.

### SUMMARY

Therefore, there is a need for systems and methods which avoid, reduce or overcome the limitations of the prior art.

Developers of the present technology have appreciated that the text suggests can be generated taking into account a specific application to which the user has provided the textual input. More specifically, certain non-limiting embodiments of the present technology are directed to method and system to training a machine-learning (ML) model to generate text suggests based on: (i) a current user input to the given application of a plurality of applications executed on a given electronic device; and (ii) a respective application name of the given application.

In other words, at least some non-limiting embodiments of the present methods and systems include generating specific embeddings of the application names of the plurality of applications and use such embeddings for training and using the ML model to generate different text suggests depending on a particular application, to which the user is currently entering their textual input. By doing so, the present methods and systems may allow generating more text suggests that would be more expected by the user for the particular application, which may improve the user experience of the user from interacting with either one of both of the electronic device, on the whole, and the given application, in particular.

More specifically, in accordance with a first broad aspect of the present technology, there is provided a computer-implemented method for generating text suggests for texts input in one of a plurality of applications executed on an electronic device. The method comprises: receiving, from a user of the electronic device, a textual user input; generating a first vector embedding representative of the textual user input; generating a second vector embedding representative of an application name of a given application of the plurality of applications, to which the textual user input has been made; combining the first and second vector embeddings to generate a combined vector embedding for the textual user input; feeding the combined vector embedding to a natural language processing model (NLPM) to generate a text suggest for the user to select as input, to the given application, following the textual user input, the NLPM having been trained to generate text suggests based on current user inputs to each one of the plurality of applications based at least in part on the application names thereof; and outputting the text suggest to enable the user of the electronic device to input the text suggest after the textual user input to the given application.

In some implementations of the method, the generating the first vector embedding comprising using a text embedding algorithm based on a convolutional neural network (CNN).

In some implementations of the method, the text embedding algorithm is a CHAR-CNN embedding algorithm.

In some implementations of the method, the generating the second vector embedding comprises applying a one-hot encoding algorithm.

In some implementations of the method, the combining comprises summing the first and second vector embeddings.

In some implementations of the method, the NLPM comprises a recurrent neural network (RNN).

In some implementations of the method, the NLPM comprises a Long Short-Term Memory (LSTM) neural network.

In some implementations of the method, the NLPM comprises a Receptance Weighted Key Value (RWKV) neural network.

In some implementations of the method, the textual user input has been made by swiping over a virtual keyboard of the electronic device with an intent to input a given symbol of a given word; and the text suggest comprises a symbol in the given word following immediately after the given symbol.

In some implementations of the method, the method further comprises determining the intent based on a curve defined by the swiping over the virtual keyboard.

In some implementations of the method, the textual user input comprises a given word and a prefix of a following word; and the text suggest comprises at least one of: a full form of the following word and a correct orthographic form of the following word.

In some implementations of the method, the full form of the following word includes a list of full form candidates for the following word.

In some implementations of the method, the correct orthographic form of the following word comprises a word combination including the following word.

In some implementations of the method, the method further comprises ranking the at least one of the full and the correct orthographic forms of the following word according to a respective value of a ranking parameter thereof; and wherein the outputting comprises outputting the at least one of the full and correct orthographic forms in a descending order of respective values of the ranking parameter thereof.

In some implementations of the method, the ranking parameter is indicative of one of: a position of the text suggest in an alphabetic order; and a confidence level of generating the text suggest.

In some implementations of the method, the text suggest for the textual user input in the given application is different from an other text suggest for the textual user input in another application of the plurality of application of the electronic device.

In some implementations of the method, the method is executed on the electronic device.

In some implementations of the method, the method further comprises training the NLPM by: acquiring a training set of data, the training set of data comprising a plurality of training digital objects, a given one of which includes: (i) a first training vector embedding representative of a given training textual user input to a training application; (ii) a second training vector embedding representative of a training name application of the training application, to which the given training textual user input has been made; and (iii) a respective label including a third training vector embedding, representative of an other training textual user input to the training application following the given textual user input; and feeding the given training digital object of the plurality of training digital objects to the NLP, minimizing, at a current training iteration, a difference between a current prediction of the NLPM and the respective label.

Further, in accordance with a second broad aspect, there is provided an electronic device for generating text suggests for texts input in one of a plurality of applications executed on the electronic device. The electronic device comprising at least one processor and at least one non-transitory computer-readable memory storing executable instructions, which, when executed by the at least one processor cause the electronic device to: receive, from a user of the electronic device, a textual user input; generate a first vector embedding representative of the textual user input; generate a second vector embedding representative of an application name of a given application of the plurality of applications, to which the textual user input has been made;

combine the first and second vector embeddings to generate a combined vector embedding for the textual user input; feed the combined vector embedding to a natural language processing model (NLPM) to generate a text suggest for the user to select as input, to the given application, following the textual user input, the NLPM having been trained to generate text suggests based on current user inputs to each one of the plurality of applications based at least in part on the application names thereof; and output the text suggest to enable the user of the electronic device to input the text suggest after the textual user input to the given application.

In some implementations of the electronic device, to generate the first vector embedding, the at least one processor causes the electronic device to apply, to the textual user input, a CHAR-CNN embedding algorithm.

In the context of the present specification, a “server” is a computer program that is running on appropriate hardware and is capable of receiving requests (e.g. from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices, however it is not required to be the case with respect to the present technology. Thus, some (non-limiting) examples of electronic devices include self-driving unit, personal computers (desktops, laptops, netbooks, etc.), smartphones, and tablets, as well as network equipment such as routers, switches, and gateways. It should be understood that in the present context the fact that the device functions as an electronic device does not mean that it cannot function as a server for other electronic devices.

In the context of the present specification, the expression “information” includes information of any nature or kind whatsoever capable of being stored in a database. Thus information includes, but is not limited to visual works (e.g. maps), audiovisual works (e.g. images, movies, sound records, presentations etc.), data (e.g. location data, weather data, traffic data, numerical data, etc.), text (e.g. opinions, comments, questions, messages, etc.), documents, spreadsheets, etc.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system configurable for implementing certain non-limiting embodiments of the present technology;

FIG. 2 depicts a schematic diagram of a networked computing environment comprising the computer system of FIG. 1 and being suitable for use with certain non-limiting embodiments of the present technology;

FIGS. 3 and 4 schematically depict graphical user interfaces (GUIs) of example applications executed on an electronic device present in the networked computing environment of FIG. 2, enabling a user to make textual inputs using a virtual keyboard of the electronic device, in accordance with certain non-limiting embodiments of the present technology;

FIG. 5 depicts a schematic diagram of a machine-learning architecture that can be used for implementing certain non-limiting embodiments of the present technology;

FIG. 6 depicts a schematic diagram of a training process of a natural language processing model (NLPM), implemented based on the machine-learning architecture of FIG. 5, for training the NLPM to generate text suggests responsive to textual inputs to the GUIs of the applications of FIGS. 3 and 4, in accordance with certain non-limiting embodiments of the present technology;

FIG. 7 depicts a schematic diagram of an in-use process of the NLPM executed by the electronic device present in the networked computing environment of FIG. 2, in accordance with certain non-limiting embodiments of the present technology;

FIG. 8 schematically depicts the GUI of FIG. 4 illustrating the text suggests that have been generated, by the electronic device of the networked computing environment of FIG. 2, during the in-use process of the NLPM, in accordance with certain non-limiting embodiments of the present technology; and

FIG. 9 depicts a flowchart diagram of a method for generating the text suggests by the electronic device present on the networked computing environment of FIG. 2, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

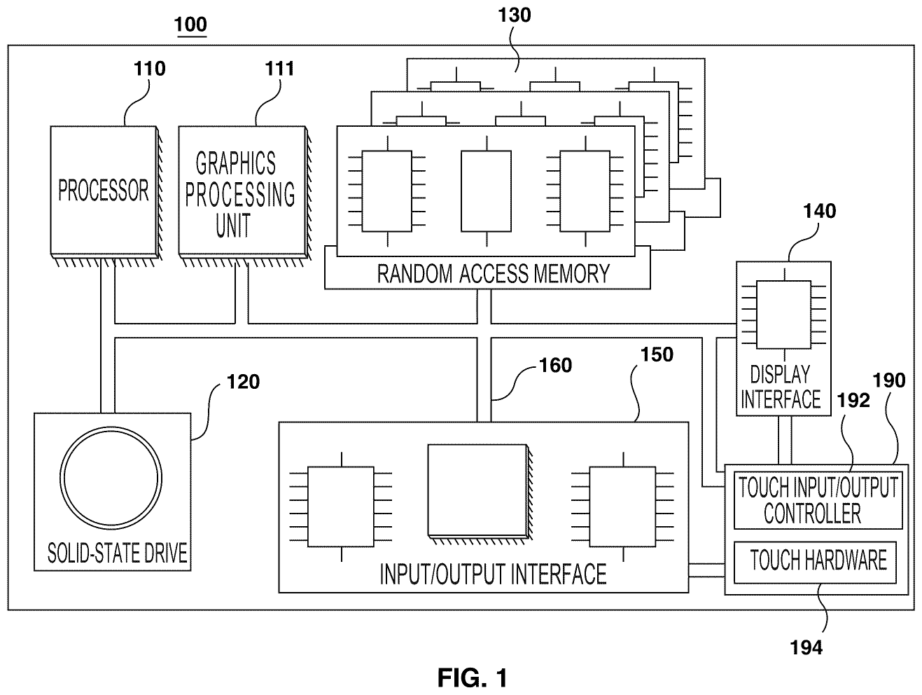

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

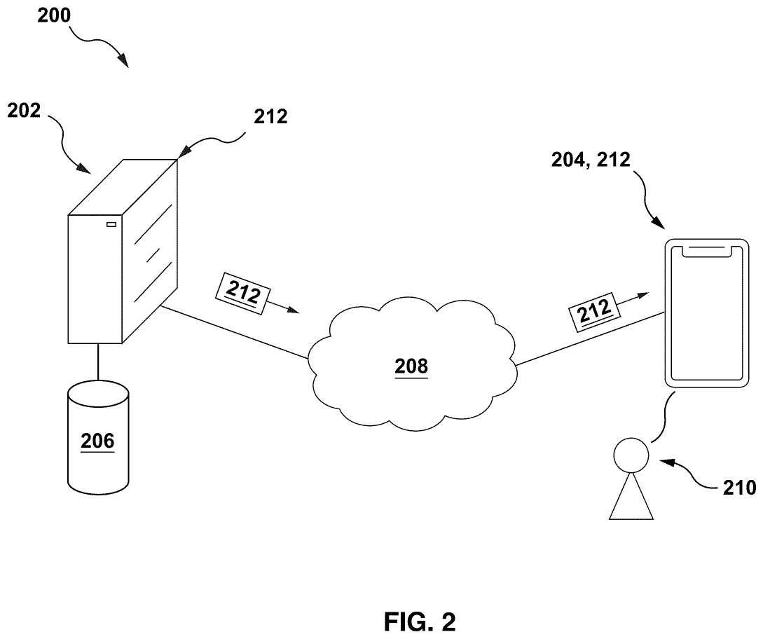

The input/output interface 150 may be coupled to a touchscreen 190 and/or to the one or more internal and/or external buses 160. The touchscreen 190 may equally be referred to as a screen-such as a screen (not separately labelled) of an electronic device 204 depicted in FIG. 2. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some non-limiting embodiments of the present technology, the input/output interface 150 may be connected to a keyboard (not separately depicted), a mouse (not separately depicted) or a trackpad (not separately depicted) allowing the user to interact with the computer system 100 in addition to or instead of the touchscreen 190.

It is noted some components of the computer system 100 can be omitted in some non-limiting embodiments of the present technology. For example, the keyboard and the mouse (both not separately depicted) can be omitted, especially (but not limited to) where the computer system 100 is implemented as a compact electronic device, such as a smartphone.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

With reference to FIG. 2, there is depicted a networked computing environment 200 suitable for use with some non-limiting embodiments of the present technology. The networked computing environment 200 includes an electronic device 204 communicatively coupled, via a communication network 208, with a server 202. In some non-limiting embodiments of the present technology, the electronic device 204 may be associated with a user 210.

In the non-limiting embodiments of the present technology, the electronic device 204 may be any computer hardware that is capable of running a software appropriate to the relevant task at hand. Thus, some non-limiting examples of the electronic device 204 may include personal computers (desktops, laptops, netbooks, etc.), smartphones, and tablets. Thus, the electronic device 204 may comprise some or all components of the computer system 100 depicted in FIG. 1.

In some non-limiting embodiments of the present technology, the server 202 can be implemented as a conventional computer server and may comprise some or all of the components of the computer system 100 of FIG. 1. In one non-limiting example, the server 202 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 202 is a single server. In alternative non-limiting embodiments of the present technology (not depicted), the functionality of the server 202 may be distributed and may be implemented via multiple servers.

According to some non-limiting embodiments of the present technology, the electronic device 204 can be configured to execute a plurality of applications that have been pre-installed on the electronic device 204. According to certain non-limiting embodiments of the present technology, the plurality of application can include both (1) web-based applications, that is, those that are delivered and executed via a web browser (which can also be one of the plurality of applications) of the electronic device 204; and (2) native applications, that is, those that have been specifically developed for an operating system of the electronic device 204. For example, the native applications can be developed for a Microsoft™ Windows™ operating system, an Apple™ iOS™ operating system, or a Google™ Android™ operating system and mobile versions thereof.

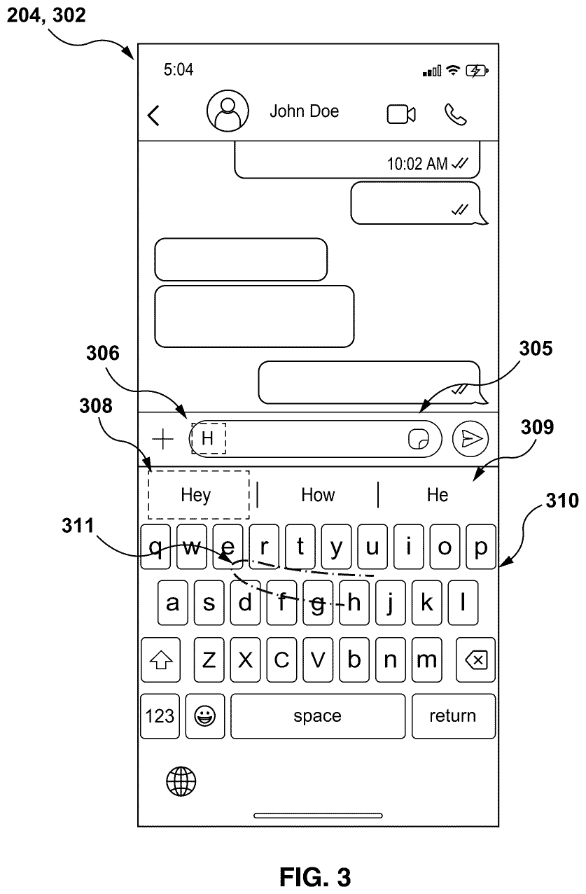

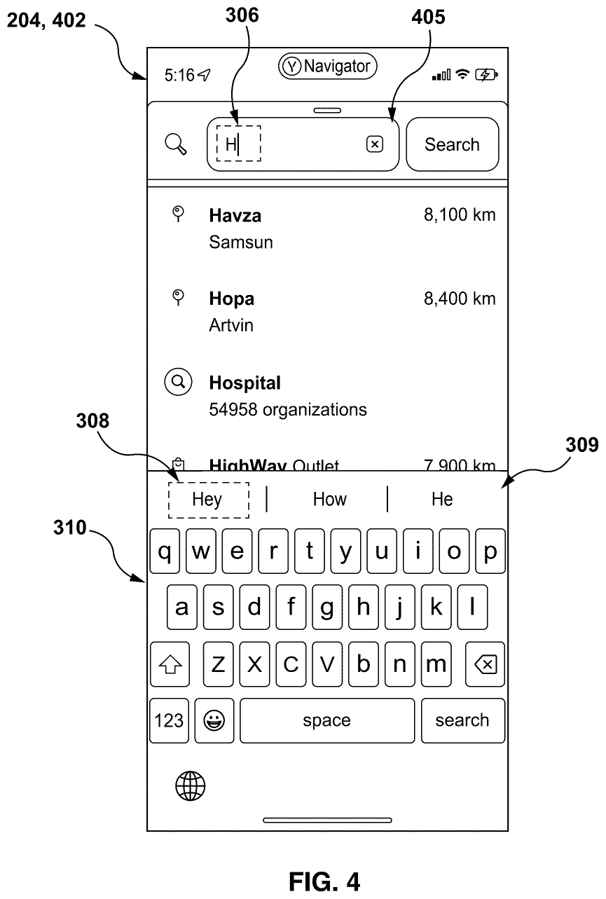

By way of example, and not as a limitation, the plurality of applications executed by the electronic device 204 can include a messenger application 302, a graphical user interface (GUI) of which is schematically depicted in FIG. 3, in accordance with certain non-limiting embodiments of the present technology. Non-limiting examples of the messenger application 302 can include a WhatsApp™ messenger application, a Telegram™ messenger application, and Viber™ messenger application. In another example, the plurality of applications of the electronic device 204 can include a navigation application 402, a GUI of which is schematically depicted in FIG. 4, in accordance with certain non-limiting embodiments of the present technology. Various examples of the navigation application 402 can include a Yandex™ Navigator™ navigation application, a Google™ Maps™ navigation application, or a Waze™ navigation application.

Other applications (not depicted) of the plurality of applications executed by the electronic device 204 can include, without limitation, a banking application (such as a Citibank™ banking application); subscription-based applications, such as an application of a video hosting platform (such as a YouTube™ video hosting platform) or an application of an audio hosting platform (such as a Yandex™ Music™ audio hosting platform); applications associated with online listing platforms (such as Yandex™ Market™ online listing platform); and others.

With continued reference to FIGS. 3 and 4, according to certain non-limiting embodiments of the present technology, a respective GUI of a given application of the plurality of application, such as one of the messenger application 302 and the navigation application 402, may require textual inputs from the user 210; and as such, these applications can be configured to provide the user 210 with a user-activatable text field for inputting text to the given application. Generally, implementation of such user-activatable text field depends on a particular implementation of the given application. For example, the messenger application 302 can be configured to provide a message bar 305 for inputting text thereto, which is generally representative of a message to a respective addressee. In the other example, the navigation application 402 can be configured to provide a search bar 405 inputting text thereto, which is generally representative of a desired destination. Other implementations of the user-activatable text field can include, without limitation, a user login/password bars in the given application, a word search bar in a dictionary application, a web address bar in a browser application.

Further, for providing the user 210 with a capability of inputting the text to the user-activatable text field, according to certain non-limiting embodiments of the present technology, in response to the user 210 actuating (such as clicking or tapping) the user-activatable text field in the given application, the electronic device 204 can be configured to provide a virtual keyboard 310. For example, the electronic device 204 can be configured to cause the virtual keyboard 310 to pop-up in response to the user 210 actuating the user-activatable text field.

Generally speaking, the virtual keyboard 310 is a GUI element including a plurality of actuators that mimic keys of a physical keyboard. The plurality of actuators can be displayed on a screen of the electronic device and, depending on an implementation of the screen, such as a sensor/non-sensor screen, the plurality of keys can be actuated by the user 210 either one or both by tapping or clicking (such as by a mouse or stylus) on the plurality of keys. Although, in the illustrated embodiments, the virtual keyboard 310 has a QWERTY layout, other keyboard layouts, such as AZERTY, QWERTZ, or QZERTY, and alphabets, such as different national variations of Latin- and Cyrillic-based alphabets, for the virtual keyboard 310 are also envisioned.

Thus, by providing the virtual keyboard 310, the electronic device 204 enables the user 210 to make a given textual input 306, for example, to the message bar 305 of the messenger application 302. As mentioned above, to make the given textual input 306, the user 210 can either click or tap on a respective actuator (corresponding to letter “H” in the present example) of the virtual keyboard 310. In yet another example, as will become apparent from the description provided below, the given textual input 306 can be generated by the user 210 swiping over the virtual keyboard, such as along a swipe curve 311.

According to certain non-limiting embodiments of the present technology, the virtual keyboard 310 can include a suggest bar 309. Broadly speaking, the suggest bar 309 is configured to output suggests, such as a suggest 308, generated by the electronic device 204, for the given textual input 306. In the context of the present technology, the term “suggest”, such as the suggest 308, denotes at least one of at least one immediately following symbol, a full or orthographically correct form of a given word or phrase that are automatically generated based on the given textual input 306. As best shown in the example, based on the given textual input 306 including a prefix “H”, the electronic device 204 can be configured to generate the suggest 308 reading “Hey” that the user 210 can select without having to type in each character of the word “Hey,” which may facilitate typing in the message.

According to certain non-limiting embodiments of the present technology, the electronic device 204 can be configured to generate the suggest 308 based on past user textual inputs of the user 210 using the virtual keyboard 310. For example, the electronic device 204 may determine that most frequent completion of the prefix “H” by the user 210 (or other users) is the word “Hey,” and as such, in response to receiving the given textual input 306 next time, automatically generate the suggest 308. In those embodiments where the given textual input 306 has been made by the user 210 swiping over the virtual keyboard 310, the electronic device 204 can be configured to generate the suggest 308 not only based on the past user textual inputs, but also based on geometries of past swipe curves.

However, developers of the present technology have realized that conventional implementations of the virtual keyboard 310 are configured to generate similar suggests for all the plurality of applications executed by the electronic device 204. As it can be appreciated from FIG. 4, for the navigation application 402, in response to receiving the given textual input 306 to the search bar 405, the electronic device 204 may also be configured to generate the suggest 308 as for the messenger application 302. However, the suggest 308 reading “Hey” is not aligned with the context of the navigation application 402 and may not correspond to an intent of the user 210; and therefore may be perceived by the user 210 as being futile. For example, if the intent of the user 210 was to type in the word “Hotel” or “Hospital”, indicative, for example, of the desired destination of the user 210, the user 210 would have to type it in full themselves disregarding the suggest 308. This may affect user experience not only with the navigation application 402, but also with other applications executed under the operating system of the electronic device 204.

Therefore, with continued reference to FIG. 2, the developers have developed methods and system described herein that are directed to using a specifically trained machine-learning algorithm (MLA), that is, a natural language processing model (NLPM) 212, for generating, based on the respective textual inputs, text suggests taking into account an application to which the textual inputs are being made. In other words, according to certain non-limiting embodiments of the present technology, the NLPM 212 can be trained to generate, for the given textual input 306, different suggests depending on an application to which the given textual input is being made. By doing so, the user 210 can be provided with more relevant suggests that would more closely correspond to their intent for each one of the plurality of applications of the electronic device 204. This may help improve user experience of the user 216 with the applications and electronic device 204, in general.

In some non-limiting embodiments of the present technology, the NLPM 212 can be implemented based on a Neural Network (NN). For example, in some non-limiting embodiments of the present technology, the NN can comprise a Long Short-Term memory (LSTM) NN. In other non-limiting embodiments of the present technology, the NN can comprise a recurrent neural network (RNN). In yet other non-limiting embodiments of the present technology, the NN can comprise Receptance Weighted Key Value (RWKV) NN. It should be noted that the NLPM 212 can be trained in a supervised or unsupervised manner without departing from the scope of the present technology.

According to certain non-limiting embodiments of the present technology, there can be two distinct processes executed with respect to the NLPM 212. A first process is a training process, during which the NLPM 212 is trained to generate the suggest based on various training user inputs. A second process is an in-use process, during which the NLPM 212 is used for generating in-use user suggests in response to in-use textual inputs, such as the given textual input 306. According to certain non-limiting embodiments of the present technology, the training process can be executed by the server 202, which can further be configured to transmit the trained NLPM 212 to the electronic device 204 for using the NLPM 212 for generating the in-use suggests. However, in some non-limiting embodiments of the present technology, both the training and in-use processes can be executed by the electronic device 204.

Example implementation, the training process, and the in-use process of the NLPM 212, according to certain non-limiting embodiments of the present technology, will now be described.

### Communication Network

In some non-limiting embodiments of the present technology, the communication network 208 is the Internet. In alternative non-limiting embodiments of the present technology, the communication network 208 can be implemented as any suitable local area network (LAN), wide area network (WAN), a private communication network, or the like. It should be expressly understood that implementations for the communication network are for illustration purposes only. How a respective communication link (not separately numbered) between each one of the electronic device 204, the server 202 and the communication network 208 is implemented will depend, inter alia, on how each one of electronic device 204, and the server 202 is implemented. Merely as an example and not as a limitation, in those embodiments of the present technology where the electronic device 204 is implemented as a wireless communication device such as the smartphone, the communication link can be implemented as a wireless communication link. Examples of wireless communication links include, but are not limited to, a 3G communication network link, a 4G communication network link, and the like. The communication network 208 may also use a wireless connection with the server 202 and the electronic device 204.

### Natural Language Processing Model

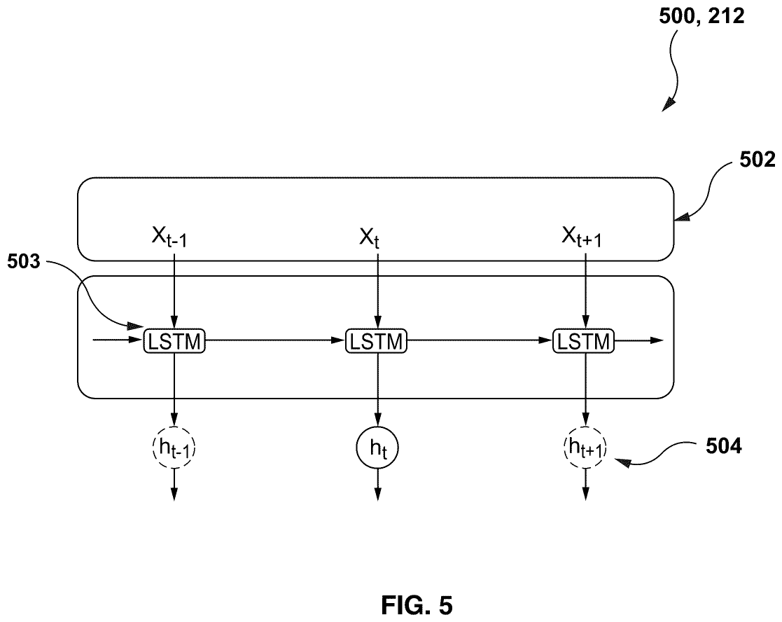

As mentioned hereinabove, in some non-limiting embodiments of the present technology, the NLPM 212 can be implemented based on the LSTM NN. With reference to FIG. 5, there is depicted a schematic diagram of a machine-learning model architecture of a LSTM NN 500 which can be used for implementation of the NLPM 212, in accordance with certain non-limiting embodiments of the present technology.

Broadly speaking, the LSTM NN 500 is a NN including so-called memory nodes, such as a memory node 503, configured for learning long-term dependencies between weights thereof over multiple training iterations. In other words, at a given iteration of training (which will be described below), the memory node 503 generates a respective current weight thereof based not only on a current weight of a node from a previous layer but also based on its previous respective weight from a previous training iteration. By doing so, the LSTM NN 500 can be configured to learn long-term dependencies among portions of input data represented by an input vector embedding 502, which further enables to generate output data, represented by an output vector embedding 504, considering context of the input data.

Depending on a target of the LSTM NN 500, the input and output data thereof can vary. For example, if the LSTM NN 500 is trained to translate text from a source language into a target language, the input data can include word or phrase in the source language, ad the output data can include a respective word or phrase on the target language. In another example, where the LSTM 500 is trained to generate a next word in a phrase-such a suggest, the input data can include a prefix of a given word or the given word itself, and the output data can include a full form of the given word or a word following the given word in phrase, respectively.

How the input and output vector embeddings 502, 504 can be generated and the training process of the NLPM 212 will now be described.

### Training Process

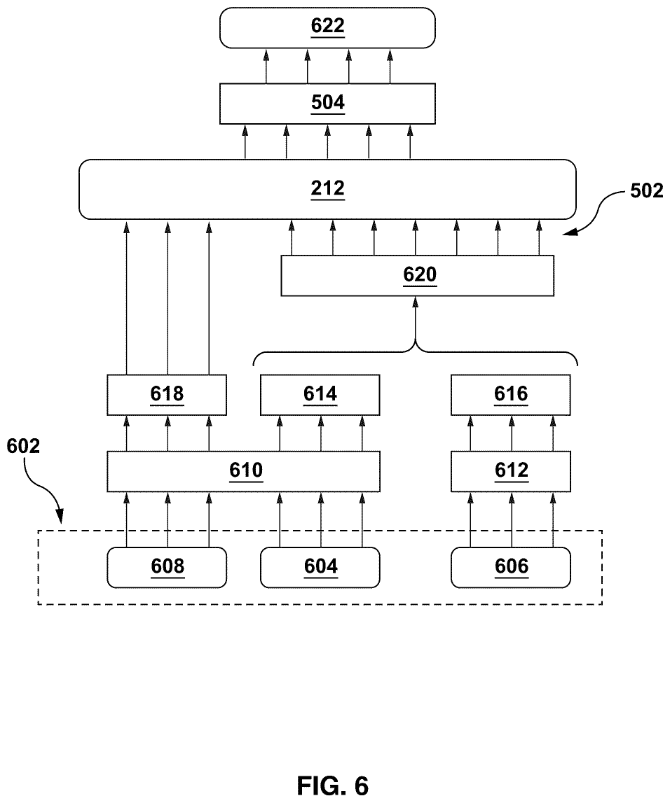

With reference to FIG. 6, there is depicted a schematic diagram of the training process of the NLPM 212, in accordance with certain non-limiting embodiments of the present technology.

As mentioned hereinabove, the NLPM 212 can be trained to generate suggests for textual inputs considering the application to which such textual inputs are being made. For example, the NLPM 212 can be trained to generate the suggest 308 reading “Hey” upon receipt of (i) the given textual input 306 including a prefix “H” and (2) an indication, such as a name, of the messenger application 302, as explained above with reference to FIG. 3.

To train the NLPM 212 to do so, according to certain non-limiting embodiments of the present technology, first, the server 202 can be configured to obtain a training set of data including a plurality of training digital objects, a given training digital object 602 of which includes: (i) a given training textual input 604 made by a training user; (ii) a name 606 of a training application, executed by a training electronic device, to which the given training textual input 604 has been made; and (iii) a respective label 608 including an other training textual input following the given training textual input 604. Needless to say, the training electronic device can be implemented similarly to the electronic device 204. The training user can be the user 210 or any other human user of electronic devices.

According to certain non-limiting embodiments of the present technology, the given training textual input 604 can include a whole word, such as “Good,” “Morning,” and others. In some non-limiting embodiments of the present technology, the given training digital object 602 can further include an indication of how the given training textual input 604 has been made, such as one of tapping, clicking, and swiping. In these embodiments, if the given training textual input 604 has been made by swiping over the virtual keyboard 310, the given training digital object 602 can further include a training swipe curve (similar to the swipe curve 311, not depicted), along which the given training textual input 604 has been made.

In some non-limiting embodiments of the present technology, the respective label 608 can include a following word in a phrase where the given word of the given training textual input 604 is being used. In some non-limiting embodiments of the present technology, the respective label 608 can include the word combination including the given word. For example, if the given training textual input 604 reads “I” the respective label 608 can read “I would like to,” such as in the phrase “I would like to inform you . . . ”

It should also be noted that in some non-limiting embodiments of the present technology, the server 202 and/or the electronic device 204 can be configured to perform spell checks of the textual inputs prior to generating the text suggests. To that end, in some non-limiting embodiments of the present technology, the respective label 608 can include a correct orthographic form of the given word.

Further, according to certain non-limiting embodiments of the present technology, the name 606 of the training application can be represented by a text string, such as “whatsapp,” “yandex navigator,” “gmail,” and others.

It is not limited how the server 202 can be configured to acquire the training set of data. In some non-limiting embodiments of the present technology, the server 202 can be configured to receive and analyze data representative of past user interactions of various training users with various implementations of the virtual keyboards 310 mentioned above in respective applications executed on training electronic devices. Also, it should be noted that in some non-limiting embodiments of the present technology, the server 202 can be configured to label the training data set automatically, by identifying, for each training text input, a respective following training input as described above, for example, based on a respective predetermined rule. The predetermined rule can include identifying at least one of: (i) an immediately following symbol; (ii) an immediately following N-gram, where N can be 2, 5, or 10; and (iii) immediately following word, as an example. In other non-limiting embodiments of the present technology, the training set of data for the training the NLPM 212 can be preliminarily labelled either by a third-party server (not depicted) or by human assessors.

For generating the input vector embedding 502 to the NLPM 212, according to certain non-limiting embodiments of the present technology, the server 202 can be configured to generate, for each component of the given training digital object 602, a respective vector embedding. To that end, in some non-limiting embodiments of the present technology, the server 202 can be configured to apply, to each one of the given training textual input 604, the respective label 608, and the name 606 of the training application, a text embedding algorithm, such as a first text embedding algorithm 610 and a second text embedding algorithm 612.

A given implementation of the first text embedding algorithm 610 depends on a particular form of the given training textual input 604 and that of the respective label 608. More specifically, in some non-limiting embodiment of the present technology, the first text embedding algorithm 610 can include a text embedding algorithm implemented based on a convolutional NN (CNN). For example, the first text embedding algorithm 610 can include a CHAR-CNN text embedding algorithm, as described in an article “Character-Aware Neural Language Models,” authored by Kim et al., and published at arxiv.org on Dec. 15, 2015, the content of which is incorporated herein by reference in its entirety.

In other non-limiting embodiments of the present technology, the first text embedding algorithm 610 can include, without limitation, one of a Word2Vec text embedding algorithm, a GloVe text embedding algorithm, and others.

According to certain non-limiting embodiments of the present technology, the second text embedding algorithm 612 can be implemented similarly to the first text embedding algorithm 610. In some non-limiting embodiments of the present technology, the second text embedding algorithm 612 can be the same as the first text embedding algorithm 610. In some non-limiting embodiments of the present technology, the second text embedding algorithm 612 can be different from the first text embedding algorithm 610. In specific non-limiting embodiments of the present technology, the second text embedding algorithm 612 can be a one-hot text embedding algorithm (also referred to herein as “one-hot encoding algorithm”). To that end, the server 202 can be configured to: (i) assign, to the name 606 of the training application associated with the given training textual input 604, a respective numerical value (such as an integer); and (ii) and process the name 606, along with other application names in other training digital objects, as a piece of categorical data.

Thus, the server 202 can be configured to generate (i) a first vector embedding 614 for the given training textual input 604; (ii) a second vector embedding for the name 606 of the training application; and (iii) a third vector embedding 618 for the respective label 608. In those embodiments where the given training digital object 602 includes the training swipe curve (not depicted), the server 202 can further be configured to generate a respective swipe curve vector including: (i) coordinates of points defining the respective swipe curve in a given coordinate system (such as a 2D Cartesian coordinate system, not depicted); and (ii) time stamps representative of respective moments in time when each of the points was generated.

It should be expressly understood that in some non-limiting embodiments of the present technology, instead of generating the vector embeddings, the server 202 can be configured to receive the given training digital object 602 including the first, second and third vector embeddings 614, 616, and 618.

In some non-limiting embodiments of the present technology, the server 202 can be configured to combine the first and second vector embeddings 614, 616, thereby generating a training combined vector embedding 620. For example, to generate the training combined vector embedding 620, the server 202 can be configured to apply, to the first and second vector embeddings 614, 616, at least one of: (i) a summation; (ii) a concatenation; and (iii) a vector multiplication.

Thus, the server 202 can be configured to generate the input vector embedding 502 to the NLPM 212. Further, to train the NLPM 212, according to certain non-limiting embodiments of the present technology, the server 202 can be configured to: (i) feed the input vector embedding 502 representative of the given training digital object 602 of the plurality of training digital objects to the NLPM 212 to generate the output vector embedding 504 representative of a current prediction 622 of the NLPM 212; and (ii) minimize a difference between the current prediction 622 and the respective label 608, thereby adjusting node weights of the NLPM 212. Such difference can be expressed by a loss function, such as one of a Cross-Entropy Loss Function, a Mean Squared Error Loss function, a Huber Loss function, a Hinge Loss function, and others.

After training the NLPM 212, the server 202 can be configured to transfer the NLPM 212, including the so determined node weights thereof, to the electronic device 204 for further use to generate text suggests during the in-use process.

It should be noted that the steps of the training process described above can be executed, mutatis mutandis, on the electronic device 204. Also, in some non-limiting embodiments of the present technology, the electronic device 204 can be configured to locally update the node weights from time to time, such as once a day, once a week, or once a month.

The in-use process will now be described.

### In-Use Process

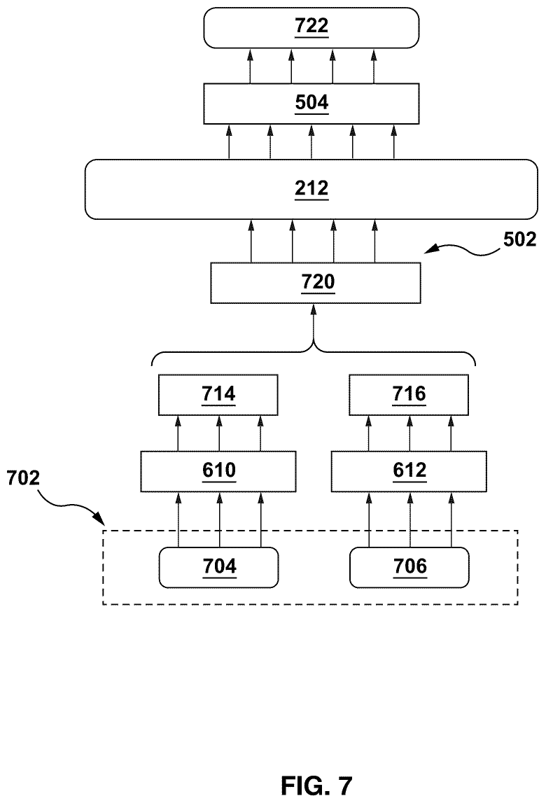

With reference to FIG. 7, there is depicted a schematic diagram of the in-use process of the NLPM 212, in accordance with certain non-limiting embodiments of the present technology. As mentioned hereinabove, the in-use process can be executed by the electronic device 204.

First, according to certain non-limiting embodiments of the present technology, during the in-use process, the electronic device 204 can be configured to generate an in-use digital object 702 including an in-use textual input 704 and an in-use name 606 of an in-use application (such as one of the messenger application 302 and the navigation application 402) to which the in-use textual input has been made. As it can be appreciated, the electronic device 204 can be configured to receive the in-use textual input 704 from the user interacting with the given application having the in-use name 704. Further, the electronic device 204 can be configured to: (i) feed the in-use textual input 704 to the first text embedding algorithm 610 to generate a first in-use vector embedding 614; and (ii) feed the in-use name 606 to the second text embedding algorithm 612 to generate a second in-use vector embedding 616. Further, according to certain non-limiting embodiments of the present technology, the electronic device 204 can be configured to combine the first and second in-use vector embeddings 614, 616 to generate an in-use combined vector embedding 620. Akin to how it is executed during the training process, the electronic device 204 can be configured to generate the in-use combined vector embedding 620 by applying, to the first and second in-use vector embeddings 614, 616, at least one of: a summation, a concatenation, and a vector multiplication.

Further, the electronic device 204 can be configured to feed the in-use combined vector embedding 620 as the input vector embedding 502 to the NLPM 212, thereby causing the NLPM 212 to generate the output vector embedding 504 representative of an in-use suggest 722. In some non-limiting embodiments of the present technology, the in-use suggest 722 comprises a single in-use suggest, such as a symbol or a word. In other non-limiting embodiments of the present technology, the in-use suggest 722 can comprise a plurality of in-use suggests responsive to the in-use textual input 704 and the in-use name 606 of the in-use application.

As mentioned while describing the training process, a form of the in-use suggest 722 depends on the form of the in-use textual input 704. For example, the in-use textual input 704 can comprise a prefix of the given word including one or more symbols, such as the given textual input 306 in FIGS. 3 and 4 reading “H”. In these embodiments, the in-use suggest 722 can comprise one of: (i) at least one immediately following symbol, such as “He,” “Ho,” or “Hel;” (ii) a full form of the given word, such as the suggest 308 reading “Hey”. Other examples can include “Hello,” “Hola,” “How,” and the like.

Also, in those non-limiting embodiments of the present technology where the in-use textual input has been made by the user 210 swiping of the virtual keyboard 310, the electronic device 204 can be configured to: (i) receive data representative of a respective swipe curve, such as the swipe curve 311 for the given textual input 306; (ii) generate a respective in-use swipe curve vector, as mentioned above; and (iii) feed the respective in-use swipe curve vector to the NLPM 212 as part of the in-use digital object 702. By doing so, the electronic device 204 can be configured to analyze the respective swipe curve to determine a user intent and generate the in-use suggestion 622 based on the user intent. In other words, the electronic device 204 can be configured to cause the NLPM 212 to generate the in-use suggest 722 that corresponds to the respective swipe curve—that is, lie thereon or lie on curves that extend along the respective swipe curve, as an example.

In another example, where the in-use textual input 704 comprises a full form of the given word and a prefix of a following word, the in-use suggest 722 can comprise one of: (i) a full form of the following word, as mentioned above with respect to the training process; and (ii) in case where the prefix or the full form of the following word includes an orthographic error—a correct orthographic form of the following word. In yet other example, the in-use suggest 722 can comprise a word combination including the following word. For example, if the in-use textual input 704 reads “See y . . . ,” the electronic device 204 can generate the in-use suggest 722 reading at least one of “See you later,” “See you tomorrow,” or “See you soon.”

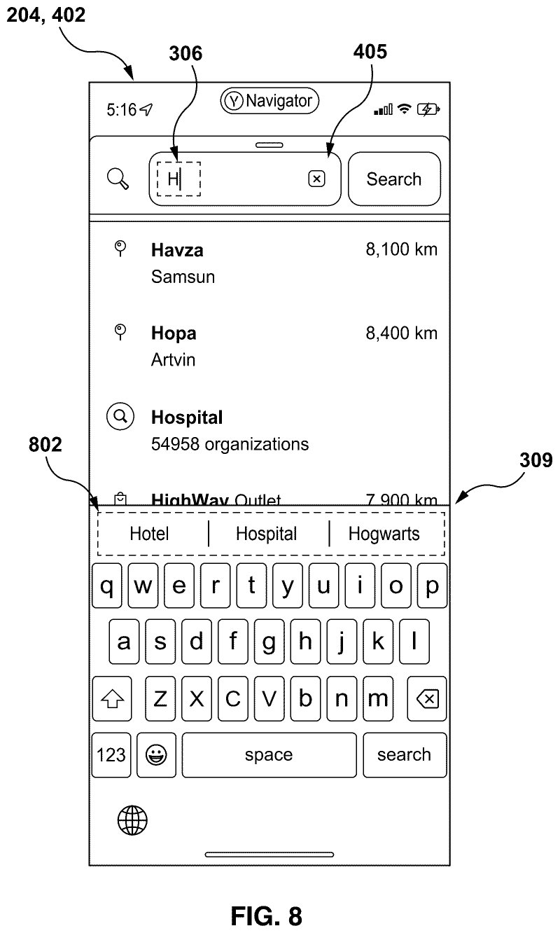

Thus, as schematically depicted in FIG. 8, according to certain non-limiting embodiments of the present technology, by using the NLPM 212 trained as described above, the electronic device 204 can be configured to generate text suggests that are aligned with a context of a given application to which textual inputs are being made.

More specifically, as illustrated in an example of FIG. 8, in response to receiving the given input 306 reading “H” from the navigation application 405, the electronic device 204 can be configured to cause the NLPM 212 to generate a navigator set of in-use suggests 802 including in-use suggests reading “Hotel,” “Hospital,” and “Hogwarts,” which are believed to be better fit to the context of the navigation application 402 than the suggest 308, mentioned with reference to FIG. 4. Further, the electronic device 204 can be configured to output the set of in-use suggests to the suggest bar 306, thereby enabling the user 210 to select one of the navigator set of in-use suggests 802 completing the given textual input 306.

In some non-limiting embodiments of the present technology, prior to outputting the navigator set of in-use suggests 802, the electronic device 204 can be configured to rank the navigator set of in-use suggests 802 in accordance with a respective value of a ranking parameter. In some non-limiting embodiments of the present technology, the ranking parameter can include a confidence level with which the NLPM 212 has generated a given one of the navigator set of in-use suggests 802. For example, if, in response to submitting the given textual input 306, the NLPM 212 has generated a first suggest “Hotel” with a first value of the confidence level being 0.98 and a second suggest “Hogwarts” with a second value of the confidence level being 0.70, the first suggest will be ranked higher than the second suggest. In other non-limiting embodiments of the present technology, the ranking parameter can include an alphabetic order. In these embodiments, the second suggest will be ranked higher than the first suggest.

Thus, the present methods and systems of generating text suggests may allow generating more relevant text suggests, which may improve the user experience of the user 210 interacting with the plurality of application executed on the electronic device 204.

### Computer-Implemented Method

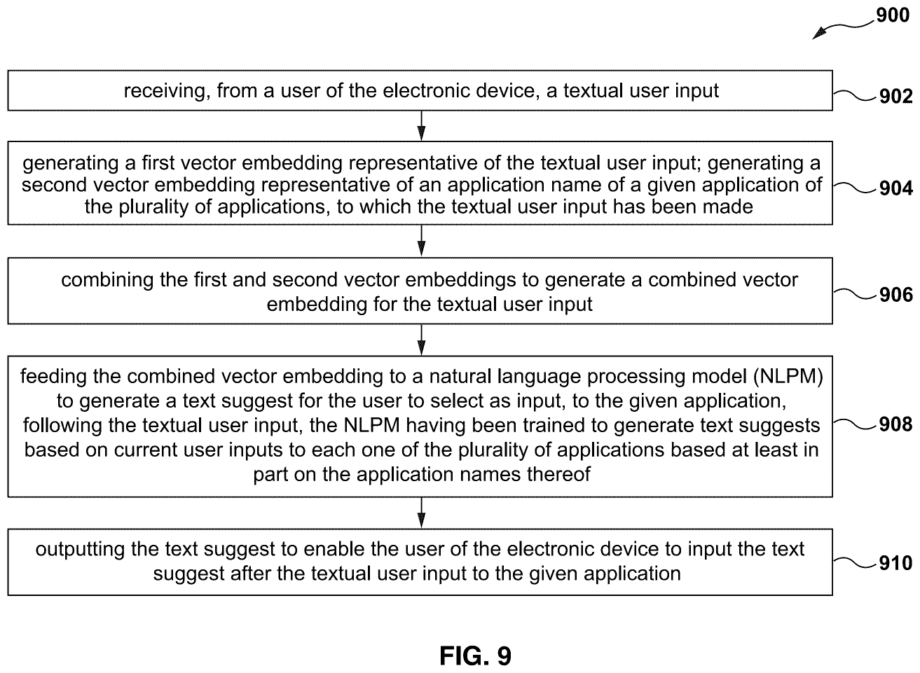

Given the architecture and the examples provided hereinabove, it is possible to execute a method for generating text suggest, such as the navigator set of in-use suggests 802. With reference now to FIG. 9, there is depicted a flowchart of a method 900, according to the non- limiting embodiments of the present technology. The method 900 may be executed by the processor 110 of the electronic device 204. As noted above, the electronic device 204 can be configured to execute plurality of applications, such as the messenger application 302 and the navigation application 402, which can be configured to require textual inputs from the user 210, such as the given textual input 306.

### Step 902: Receiving, From a User of the Electronic Device, a Textual User Input

The method 900 commences at step 902 with the processor 110 of the electronic device 204 being configured to receive, from the user 210 of the electronic device 204, the given textual input 306 via one of the plurality of applications, such as one of the messenger application 302 and the navigation application 402.

According to certain non-limiting embodiments of the present technology, the electronic device 204 can be configured to enable the user 210 to make the given textual input 306 by providing the virtual keyboard 310. Thus, the user 210 can provide the given textual input 306 by one of tapping, clicking, or swiping over respective actuators of the virtual keyboard 310.

In some non-limiting embodiments of the present technology, the given textual input 306 can include a prefix of the given word including at least one symbol. In other non-limiting embodiments of the present technology, the given textual input 306 can include a full form of the given word.

The method 900 hence advances to step 904.

Step 904: Generating a First Vector Embedding Representative of the Textual User Input; Generating a Second Vector Embedding Representative of an Application Name of a Given Application of the Plurality of Applications, to Which the Textual User Input has Been Made

At step 904, according to certain non-limiting embodiments of the present technology, the processor 110 can be configured to generate: (i) using the first text embedding algorithm 610, the first in-use vector embedding 614 of the given textual input 306; and (ii) using the second text embedding algorithm 612, the second in-use vector embedding 616 of the in-use name 606 of one of the messenger and navigation applications 302, 402. Details on how each one of the first and second text embedding algorithms 610, 612 can be implemented, in accordance with certain non-limiting embodiments of the present technology, are described above with reference to FIG. 6.

The method 900 hence advances to step 906.

### Step 906: Combining the First and Second Vector Embeddings to Generate a Combined Vector Embedding for the Textual User Input

At step 906, the processor 110 can be configured to combine the first and second in-use vector embeddings 614, 616 to generate the in-use combined vector embedding 620. To do so, in various non-limiting embodiments of the present technology, the processor 110 can be configured to apply, to the first and second in-use vector embeddings 614, 616, at least one of: a summation, a concatenation, and a vector multiplication.

The method 900 hence advances to step 908.

Step 908: Feeding the Combined Vector Embedding to a Natural Language Processing Model (NLPM) to Generate a Text Suggest for the User to Select as Input, to the Given Application, Following the Textual User Input, the NLPM Having Been Trained to Generate Text Suggests Based on Current User Inputs to Each One of the Plurality of Applications Based at Least in Part on the Application Names Thereof

At step 908, the processor 110 can be configured to feed the in-use combined vector embedding 620 to the NLPM 212, thereby causing the NLPM 212 to generate the output data 504 representative of the in-use suggest 722, as described above with reference to FIGS. 7 and 8. How the NLPM 212 could be trained to generate the text suggest has been described above with reference to FIGS. 5 and 6.

According to certain non-limiting embodiments of the present technology, the in-use suggest 722 can include one of: at least one immediately symbols to be appended to the given textual input 306; a full form of the given word, a prefix of which has been received in the given textual input 306; a correct orthographic form of the given word if it is determined that the given textual input 306 includes the prefix or the full form of the given word with an orthographic error; a word combination with the given word, the prefix of which has been received in the given textual input 306. As mentioned hereinabove with reference to FIGS. 7 and 8, according to some non-limiting embodiments of the present technology, the in-use suggest 722 can include a single suggest, such as the suggest 308 in the messenger application 302. In other non-limiting embodiments of the present technology, the in-use suggest 722 can include a plurality of in-use suggests, such as the navigator set of in-use suggests 802 in the navigation application 402.

In those embodiments where the processor 110 is configured to cause the NLPM 212 to generate the navigator set of in-use suggests 802, the processor 110 can further be configured to rank the set of in-use suggests according to respective values of the ranking parameter of each one of the navigator set of in-use suggests 802. For example, the ranking parameter can include the confidence level with which the NLPM 212 generate the given in-use suggest of the navigator set of in-use suggests 802. In another example, the ranking parameter can include the alphabetic order.

The method 900 hence advances to step 910.

### Step 910: Outputting the Text Suggest to Enable the User of the Electronic Device to Input the Text Suggest After the Textual User Input to the Given Application

At step 910, the processor 110 of the electronic device 204 can be configured to output the in-use suggest 722 to the suggest bar 309 of the virtual keyboard 310, thereby enabling the user 210 to select the in-use suggest 722 for completing the given textual input 306.

Thus, certain non-limiting embodiments of the method 900 allow considering the context of the given application when generating text suggests to respective textual inputs to these applications. More specifically, if the user 210 inputs the given textual input 306 “H” to the messenger application 302, the processor 110 can be configured to generate the in-use suggest 722 including the suggest 308 reading “Hey,” as schematically depicted in FIG. 3, which contextually relates to the messenger application 302. In another example, if the user 210 enters the given textual input 306 reading “H” to the navigation application 402, the processor 110 can be configured to generate the navigator set of in-use suggests 802 including text suggests reading “Hotel,” “Hospital,” and “Hogwarts.” As each in-use suggest of the navigator set of in-use suggests 802 is representative of a respective destination, it is believed to be contextually closer to the navigation application 402 than the suggest 308, as depicted on FIG. 4.

Therefore, certain non-limiting embodiments of the method 900 may help increase user satisfaction of the user 210 from interacting with the plurality of applications executed by the electronic device 204 and the electronic device 204 itself, in general.

The method 900 hence terminates.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A computer-implemented method for generating text suggests for texts input in one of a plurality of applications executed on an electronic device, the method comprising:
receiving, from a user of the electronic device, a textual user input;
generating a first vector embedding representative of the textual user input;
generating a second vector embedding representative of an application name of a given application of the plurality of applications, to which the textual user input has been made;
combining the first and second vector embeddings to generate a combined vector embedding for the textual user input;
feeding the combined vector embedding to a natural language processing model (NLPM) to generate a text suggest for the user to select as input, to the given application, following the textual user input,
the NLPM having been trained to generate text suggests based on current user inputs to each one of the plurality of applications based at least in part on the application names thereof; and
outputting the text suggest to enable the user of the electronic device to input the text suggest after the textual user input to the given application.

2. The method of claim 1, wherein the generating the first vector embedding comprising using a text embedding algorithm based on a convolutional neural network (CNN).

3. The method of claim 2, wherein the text embedding algorithm is a CHAR-CNN embedding algorithm.

4. The method of claim 1, wherein the generating the second vector embedding comprises applying a one-hot encoding algorithm.

5. The method of claim 1, wherein the combining comprises summing the first and second vector embeddings.

6. The method of claim 1, wherein the NLPM comprises a recurrent neural network (RNN).

7. The method of claim 1, wherein the NLPM comprises a Long Short-Term Memory (LSTM) neural network.

8. The method of claim 1, wherein the NLPM comprises a Receptance Weighted Key Value (RWKV) neural network.

9. The method of claim 1, wherein:
the textual user input has been made by swiping over a virtual keyboard of the electronic device with an intent to input a given symbol of a given word; and
the text suggest comprises a symbol in the given word following immediately after the given symbol.

10. The method of claim 9, further comprising determining the intent based on a curve defined by the swiping over the virtual keyboard.

11. The method of claim 1, wherein:
the textual user input comprises a given word and a prefix of a following word; and
the text suggest comprises at least one of: a full form of the following word and a correct orthographic form of the following word.

12. The method of claim 11, wherein the full form of the following word includes a list of full form candidates for the following word.

13. The method of claim 11, wherein the correct orthographic form of the following word comprises a word combination including the following word.

14. The method of claim 11, further comprising:
ranking the at least one of the full and the correct orthographic forms of the following word according to a respective value of a ranking parameter thereof; and
wherein the outputting comprises outputting the at least one of the full and correct orthographic forms in a descending order of respective values of the ranking parameter thereof.

15. The method of claim 14, wherein the ranking parameter is indicative of one of: a position of the text suggest in an alphabetic order; and a confidence level of generating the text suggest.

16. The method of claim 1, wherein the text suggest for the textual user input in the given application is different from an other text suggest for the textual user input in another application of the plurality of application of the electronic device.

17. The method of claim 1, wherein the method is executed on the electronic device.

18. The method of claim 1, further comprising training the NLPM by:
acquiring a training set of data, the training set of data comprising a plurality of training digital objects, a given one of which includes: (i) a first training vector embedding representative of a given training textual user input to a training application; (ii) a second training vector embedding representative of a training name application of the training application, to which the given training textual user input has been made; and (iii) a respective label including a third training vector embedding, representative of an other training textual user input to the training application following the given textual user input; and
feeding the given training digital object of the plurality of training digital objects to the NLP, minimizing, at a current training iteration, a difference between a current prediction of the NLPM and the respective label.

19. An electronic device for generating text suggests for texts input in one of a plurality of applications executed on the electronic device, the electronic device comprising at least one processor and at least one non-transitory computer-readable memory storing executable instructions, which, when executed by the at least one processor cause the electronic device to:
receive, from a user of the electronic device, a textual user input;
generate a first vector embedding representative of the textual user input;
generate a second vector embedding representative of an application name of a given application of the plurality of applications, to which the textual user input has been made;
combine the first and second vector embeddings to generate a combined vector embedding for the textual user input;
feed the combined vector embedding to a natural language processing model (NLPM) to generate a text suggest for the user to select as input, to the given application, following the textual user input,
the NLPM having been trained to generate text suggests based on current user inputs to each one of the plurality of applications based at least in part on the application names thereof; and
output the text suggest to enable the user of the electronic device to input the text suggest after the textual user input to the given application.

20. The electronic device of claim 19, wherein to generate the first vector embedding, the at least one processor causes the electronic device to apply, to the textual user input, a CHAR-CNN embedding algorithm.
